(19) United States
(12) Patent Application Publication
(10) Pub. No.: US 2004/0026495 A1
(43) Pub. Date: Feb. 12, 2004

(54) Transaction card with annunciator

(76) Inventor: Alan Finkelstein, Beverly Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/213,475

(22) Filed: Aug. 6, 2002

(51) Int. Cl. G06F 17/60

(52) U.S. Cl. 235/379; 235/487

(57) ABSTRACT

A financial transaction card includes an annunciator to generate a human perceptible indication upon activation. The annunciator may be audio, such as a pre-recorded sound, or may be visual, such as a light. The annunciator may be user-activated and/or may be activated upon use of the financial transaction card in a reading device. The annunciator, being relatively more difficult to implement than a conventional transaction card, serves to authenticate the card. Furthermore, the consumer appeal of a financial transaction card with such annunciator capability may be promoted by an issuer to attract new customers.

### BACKGROUND OF THE INVENTION

1. Field of the Invention

This invention relates generally to the field of financial transaction cards, such as credit cards, debit cards, and the like. More particularly, the invention relates to a transaction card with an audio and/or visual annunciator that is triggered when the card is used to conduct a financial transaction.

2. Background

Financial transaction cards are widely used. Such cards include credit cards, debit cards, and the like. Financial transaction cards also include assigned value cards, such as gift cards.

Fraud has become a significant problem for transaction cards of all types. Counterfeit cards are relatively easy to make and are often accepted by merchants without proper verification. Numerous approaches have been adopted to combat transaction card fraud. For example, most transaction cards from financial institutions now have holographic designs which are more difficult to counterfeit. Also, many transaction cards now include a photographic image of the card owner; however, this is more effective in preventing unauthorized use of a lost or stolen card than it is for stopping the use of counterfeit cards.

At the same time that transaction card issuers are attempting to combat fraud, they are also attempting to differentiate their cards from those of other issuers so as to improve their market share. Transaction cards with new features and functions are being introduced to attract new customers and to establish brand identity.

### SUMMARY OF THE INVENTION

The present invention provides a financial transaction card that complies with all applicable ISO standards and that includes an annunciator to generate a human perceptible indication upon activation. The annunciator may be audio, such as a pre-recorded sound, or may be visual, such as a light. The annunciator may be user-activated and/or may be activated upon use of the financial transaction card in a reading device. The annunciator, being relatively more difficult to implement than a conventional transaction card, serves to authenticate the card. Furthermore, the consumer appeal of a financial transaction card with such annunciator capability may be promoted by an issuer to attract new customers.

### BRIEF DESCRIPTION OF THE DRAWINGS

FIG. 1 is a plan view of the front of the financial transaction card constructed in accordance with an embodiment of the present invention;

FIG. 2 is a plan view of the rear of the financial transaction card shown in FIG. 1;

FIG. 3 is a functional block diagram of the operational components of a financial transaction card having an audio annunciator;

FIG. 4 is a functional block diagram of the operational components of a financial transaction card having a visual annunciator.

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

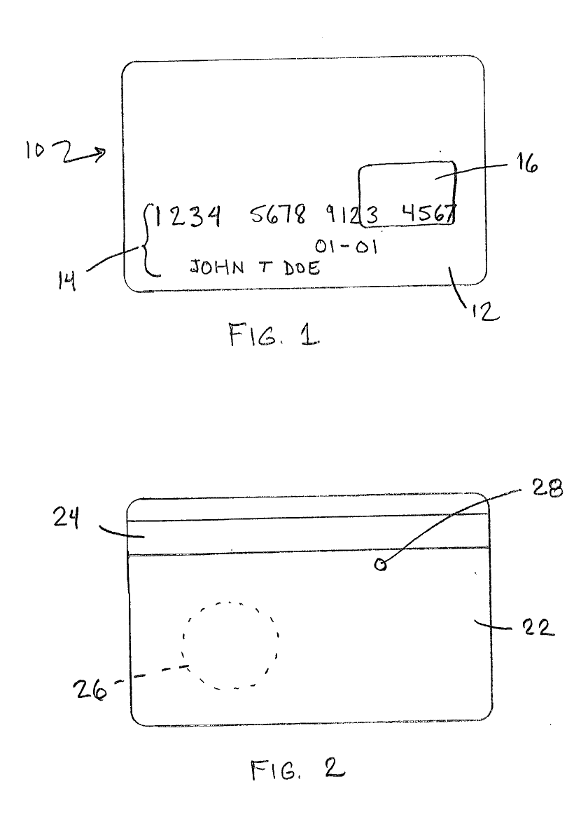

FIG. 1 shows the front side 12 of a financial transaction card 10 constructed in accordance with an embodiment of the present invention. In general, card 10 has the same outward appearance as a conventional financial transaction card. As is typical of financial transaction cards, the front of card 10 may be embossed with alphanumeric data 14, which may include an account number, name of the card holder, expiration date, etc. A holographic design 16 is also typically displayed on the front of the card. The front surface 12 may also be imprinted with the name of the issuer, logotypes, and/or other artwork.

FIG. 2 shows the rear side 22 of card 10. A magnetic strip 24 is attached to the rear of the card. The magnetic strip is encoded with machine readable data identifying the account number, the cardholder, etc. The location of magnetic strip 24 and the format of the data recorded thereon are prescribed by industry standards. Most transaction cards also have a signature panel 25 on the rear surface. Card 10 may include an audio transducer 26 for generating audible sounds. Alternatively, or in addition, card 10 may include a light 28.

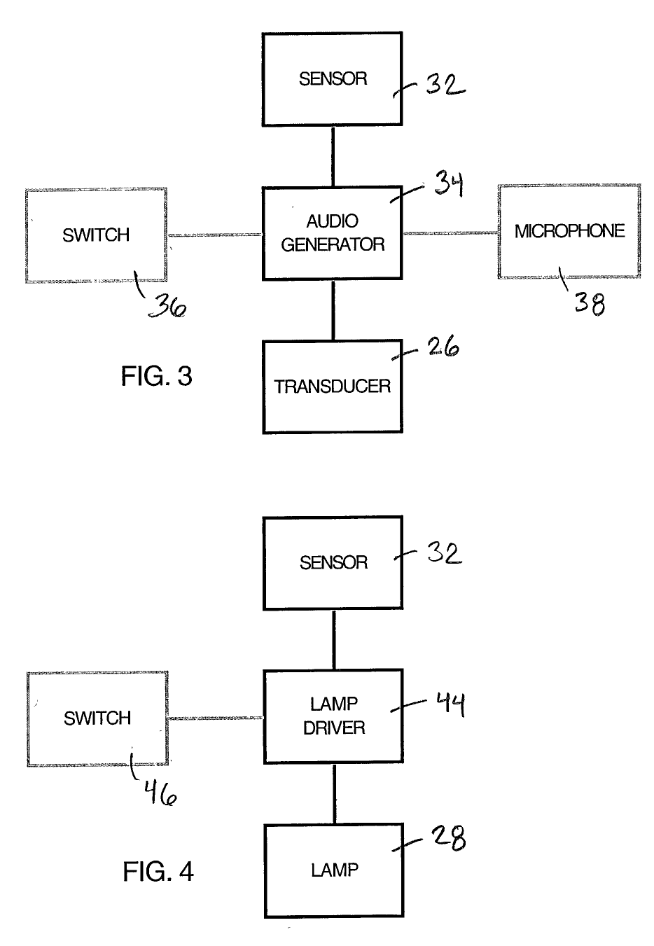

FIG. 3 is a functional block diagram of a financial transaction card, such as card 10, having an audio annunciator. A sensor 32 detects when card 10 is used to initiate a financial transaction. Typically, this occurs when the data stored on magnetic strip 24 is read by a magnetic card reader. Such an action is often referred to as “swiping” the card. Various types of sensors may be used. For example, sensor 32 may comprise a contact switch located on an edge of card 10 proximate to magnetic strip 24 to detect when the card is passed through the slot of a magnetic card reader. Alternatively, sensor 32 may comprise an optical sensor to detect the decrease in light level as card 10 is passed through a card reader. In another alternative, sensor 32 may comprise a proximity sensor to detect when card 10 is placed in the slot of a card reader. In yet another alternative, sensor 32 may comprise a magnetic sensor to detect when magnetic strip 24 is passed across the magnetic reading head of a card reader. In this regard, the magnetic strip may be specially encoded so that the sensor 32 is triggered when the specially encoded portion passes the reading head.

Whatever type of sensor is employed, sensor 32 is connected to audio generator 34. When the reading operation is sensed, audio generator 34 is triggered to produce an audio output signal. The signal may comprise a sequence of musical notes, a pre-recorded spoken message or any other distinctive audible sound. The output of audio generator 34 is coupled to transducer 26 to convert the signal into a human perceptible sound. Optionally, card 10 may include a manually operated switch 36 connected to audio generator 34. Switch 36 may be used by the card holder to produce a stored audio signal whenever desired. This signal may be the same as that triggered by sensor 32 or may be different.

As another option, card 10 may include a microphone 38 with which the card holder may record a spoken message or other sound into audio generator 34. This is particularly useful for a gift card in which the giver may record a personalized greeting to the recipient.

FIG. 4 is a functional block diagram of a visual annunciator. Sensor 32 detects a card reading operation as described above. Here, sensor 32 is connected to a lamp driver 44. The lamp driver is connected to lamp 38 and routes an electrical current to the lamp from a battery or other power source (not shown). As in the case of the audio annunciator described above, a manually operated switch 46 may be provided so that lamp 28 may be illuminated by the card holder, if desired.

The lamp driver 44 may illuminate lamp 28 steadily for a predetermined period of time or may flash the lamp in a predetermined sequence. Lamp 28 may direct a beam of light away from card 10, which may be utilized as a flashlight, or may be mounted within the substrate of card 10 so as to illuminate the issuer's logotype or other graphic upon activation. Card 10 may include a plurality of lamps arranged in a pattern which may be illuminated by lamp driver 44 to provide a variety of visual effects. For example, a plurality of lamps may be arranged to form one or more alphanumeric characters and the lamps may be driven to spell out a text message. Instead of lamps, the annunciator may also comprise a liquid crystal or similar display for displaying alphanumeric characters and other designs.

It is intended that card 10 conform to all applicable ISO standards. These standards require card 10 to have a thickness of about 0.032 inch, which presents a challenge to incorporate the necessary electronic components in such a thin substrate. This challenge can be met using the manufacturing techniques disclosed in my co-pending application Ser. No. 10/167,259, the disclosure of which is incorporated herein by reference.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A financial transaction card comprising:
a substrate;
data storage means attached to the substrate for storing machine readable data;
a sensor adapted to sense a reading operation in which the machine readable data is read by a reader separate from the financial transaction card;
an annunciator coupled to the sensor and adapted to provide a human-perceptible indication in response to the sensed reading operation.

2. The financial transaction card of claim 1 wherein the data storage means comprises a magnetic strip.

3. The financial transaction card of claim 1 wherein the data storage means comprises an electronic memory.

4. The financial transaction card of claim 1 wherein the annunciator comprises an audio generator.

5. The financial transaction card of claim 4 wherein the human-perceptible indication comprises a sequence of musical notes.

6. The financial transaction card of claim 4 further comprising means for storing an audio signal for playback by the audio generator.

7. The financial transaction card of claim 1 wherein the annunciator comprises a light.

8. The financial transaction card of claim 1 further comprising a manual control for activating the annunciator.

9. A method of verifying the authenticity of a financial transaction card comprising:
providing a financial transaction card having machine readable data and an annunciator;
providing a reader separate from the financial transaction card capable of reading the machine readable data;
sensing a reading operation;
generating a human-perceptible indication with the annunciator in response to sensing the reading operation.

10. The method of claim 9 wherein the human-perceptible indication comprises a sound.

11. The method of claim 10 wherein the sound comprises a sequence of musical notes.

12. The method of claim 9 wherein the human-perceptible indication comprises a light.

13. The method of claim 9 wherein the machine readable data is stored on a magnetic strip.

14. The method of claim 9 wherein the machine readable data is stored in an electronic memory.

15. The financial transaction card of claim 2 wherein at least a portion of the magnetic strip is encoded such that the sensor senses the reading operation of the encoded portion of the magnetic strip.

16. The method of claim 13 wherein at least a portion of the magnetic strip is encoded and wherein sensing the reading operation comprises sensing reading of the encoded portion of the magnetic strip.
